(19) United States
(12) Patent Application Publication
(10) Pub. No.: US 2013/0254204 A1
(43) Pub. Date: Sep. 26, 2013

(54) Method and Apparatus of Publishing Information

(71) Applicant: ALIBABA GROUP HOLDING LIMITED, Grand Cayman (KY)

(72) Inventors: Yizhe Liu, Hangzhou (CN); Guang Qiu, Hangzhou (CN)

(73) Assignee: Alibaba Group Holding Limited, Grand Cayman (KY)

(21) Appl. No.: 13/848,671

(22) Filed: Mar. 21, 2013

(30) Foreign Application Priority Data
Mar. 22, 2012 (CN) 201210078439.7

(51) Int. Cl. G06F 17/30

(52) U.S. Cl. CPC G06F 17/30705
USPC 707/737

(57) ABSTRACT

The present disclosure discloses a method and an apparatus of publishing information in order to solve the problems of low efficiency and accuracy of published information in existing technology. The method segments primary information of a current page, extracts at least one feature term from the current page, determines a number of times that the extracted feature term appears in the current page, determines a category of the current page based on the determined number of times that the feature term appears in the current page and a set category model, and publishes relevant information that belongs to the determined category in the current page. By directly extracting a feature term from a current page and determining a category of the current page based on a number of times that the feature term appears in the current page and a set category model, the exemplary embodiments do not need to perform manual labeling for the current page. As such, the efficiency of information publication can be improved. Furthermore, the accuracy of the information publication is increased because no human error is introduced.

### CROSS REFERENCE TO RELATED PATENT APPLICATIONS

This application claims foreign priority to Chinese Patent Application No. 201210078439.7 filed on 22 Mar. 2012, entitled “METHOD AND APPARATUS OF PUBLISHING INFORMATION,” which is hereby incorporated by reference in its entirety.

### TECHNICAL FIELD

The present disclosure relates to the field of communication technologies, and particularly, relates to methods and apparatuses of publishing information.

### BACKGROUND OF THE PRESENT DISCLOSURE

With the development of Internet technology, people can get and publish information through the Web more conveniently. When a user browses a certain web page, some relevant information that is related to primary information may be published on the web page in addition to displaying the primary information on the web page, as shown in FIG. 1.

FIG. 1 is a schematic diagram of presenting primary information in a current page and publishing relevant information that is related to the primary information in accordance with existing technologies. In FIG. 1, most of the region of the current page 101 is used to display the primary information 102, and the relevant information 103 that is related to the primary information 102 may be published in the remaining region. For example, if the primary information 102 is information related to a mobile phone of brand A, the relevant information 103 that is related to the primary information 102 is published may include information of other electronic products of brand A or information of mobile phones that have similar functionalities.

When relevant information is to be published on a certain web page, categories of web pages are needed to be classified in advance due to a diverse variety of categories of web pages. A category of the web page at issue is then determined and relevant information that belongs to the determined category is published on the web page.

Examples of classified categories may include such categories as education, military, travel, automobile, technology, etc. When publishing relevant information on a current page, a category to which the current page belongs is first determined. If the category of the current page is determined to be “automobile”, relevant information under the category “automobile” is published on the current page.

In existing technologies, a method of determining a category of a current page specifically includes: manually labeling the current page, and determining the category of the current page using a set category model based on a label corresponding to the current page. A method of setting the category model includes: manually labeling a certain number of pages with known categories, using the categories of the certain number of pages and corresponding labels as training samples, and training thereof to obtain the category model.

However, because the number of web pages is tremendous, the method of manually labeling pages not only reduces the efficiency of publishing relevant information, but also costs a lot of human resources. Furthermore, due to differences between subjective perceptions of different persons, an accuracy of manually labeling the pages is relatively low. This leads to an introduction of human errors and a possibility of publishing incorrect relevant information on the pages, thus reducing an accuracy of published information.

### SUMMARY OF THE DISCLOSURE

This Summary is provided to introduce a selection of concepts in a simplified form that are further described below in the Detailed Description. This Summary is not intended to identify all key features or essential features of the claimed subject matter, nor is it intended to be used alone as an aid in determining the scope of the claimed subject matter. The term “techniques,” for instance, may refer to device(s), system(s), method(s) and/or computer-readable instructions as permitted by the context above and throughout the present disclosure.

Exemplary embodiments of the present disclosure provide a method and an apparatus of publishing information in order to solve the problems of low efficiency and low accuracy of publishing information in existing technologies.

The exemplary embodiments of the present disclosure provide a method of publishing information, which includes:

performing term segmentation on primary information of a current page and extracting at least one feature term from the current page;

determining a number of times that the extracted feature term appears in the current page;

determining a category of the current page using a set category model based on the determined number of times that the feature term appears in the current page; and

publishing relevant information that belongs to the determined category in the current page.

The exemplary embodiments of the present disclosure provide an apparatus of publishing information, which includes:

a feature term extraction module used for performing term segmentation on primary information in a current page and extracting at least one feature term from the current page;

a frequency determination module used for determining a number of times that the extracted feature term appears in the current page;

a category determination module used for determining a category of the current page using a set category model based on the determined number times that the feature term appears in the current page; and a publication module used for publishing relevant information that belongs to determined category in the current page.

The exemplary embodiments of the present disclosure provide a method and an apparatus of publishing information. The method segments primary information of a current page, extracts at least one feature term from the current page, determines a number of times that the extracted feature term appears in the current page, determines a category of the current page using a set category model based on the determined number of times that the feature term appears in the current page, and publishes relevant information that belongs to the determined category in the current page. By directly extracting a feature term from a current page and determining a category of the current page based on a number of times that the feature term appears in the current page and a set category model, the exemplary embodiments do not need to perform manual labeling for the current page. As such, the efficiency of information publication can be improved. Furthermore, the accuracy of the information publication is increased because no human error is introduced.

### BRIEF DESCRIPTION OF THE DRAWINGS

FIG. 1 is a schematic diagram of presenting primary information in a current page and publishing relevant information that is relevant to the primary information in existing technologies.

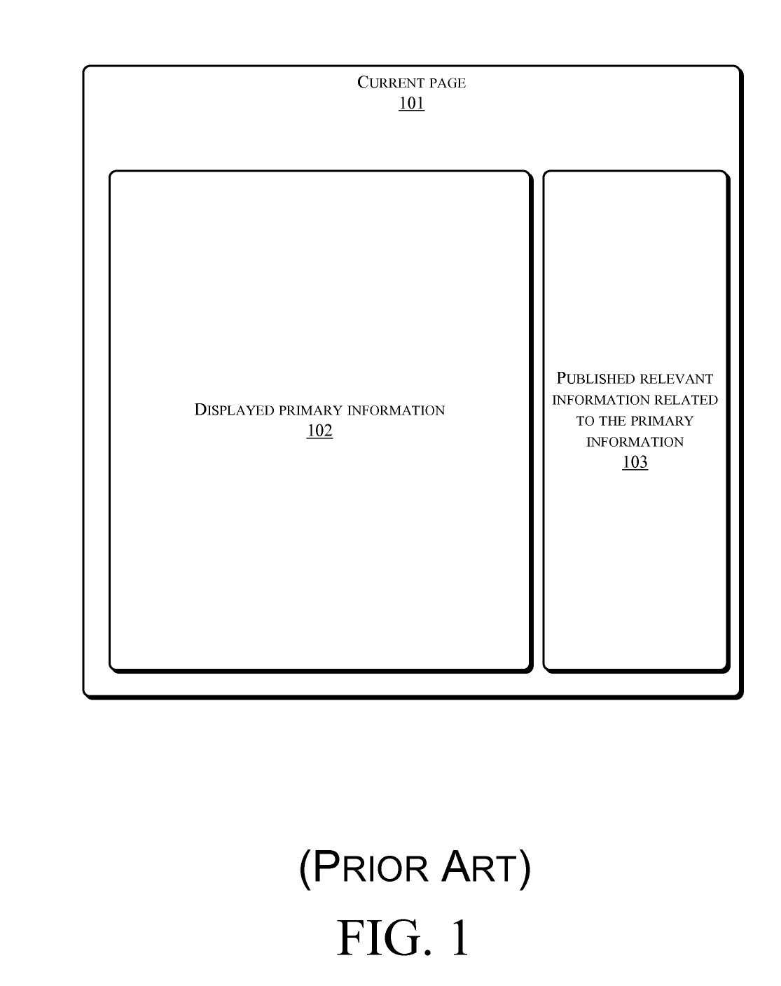

FIG. 2 is a process of publishing information in accordance with the exemplary embodiments of the present disclosure.

FIG. 3 is a process of setting a category model in accordance with the exemplary embodiments of the present disclosure.

FIG. 4 is a process of determining a category to which a current page belongs in accordance with the exemplary embodiments of the present disclosure.

FIG. 5 is a schematic diagram of an apparatus of publishing information in accordance with the exemplary embodiments of the present disclosure.

FIG. 6 is a schematic diagram of the example apparatus as described in FIG. 5.

### DETAILED DESCRIPTION

Due to a tremendous number of web pages, the method of manually labeling pages not only reduces the efficiency of publishing relevant information, but also costs a lot of human resources. Furthermore, due to differences between subjective perceptions of each person, an accuracy of manually labeling the pages is relatively low, leading to an introduction of human errors, a possibility of publishing incorrect relevant information on the pages and a reduction in the accuracy of published information. In order to improve the efficiency and the accuracy of published information, the exemplary embodiments of the present disclosure do not use the method of manually labeling web pages, but directly perform term segmentation on primary information of a current page to extract a feature term thereof. The exemplary embodiments of the present disclosure determine a category of the current page based on a number of times that the feature term appears in the current page and further based on a set category model, and publish relevant information that belongs to the determined category in the current page.

The embodiments of the present disclosure are described in details in conjunction with accompanying figures.

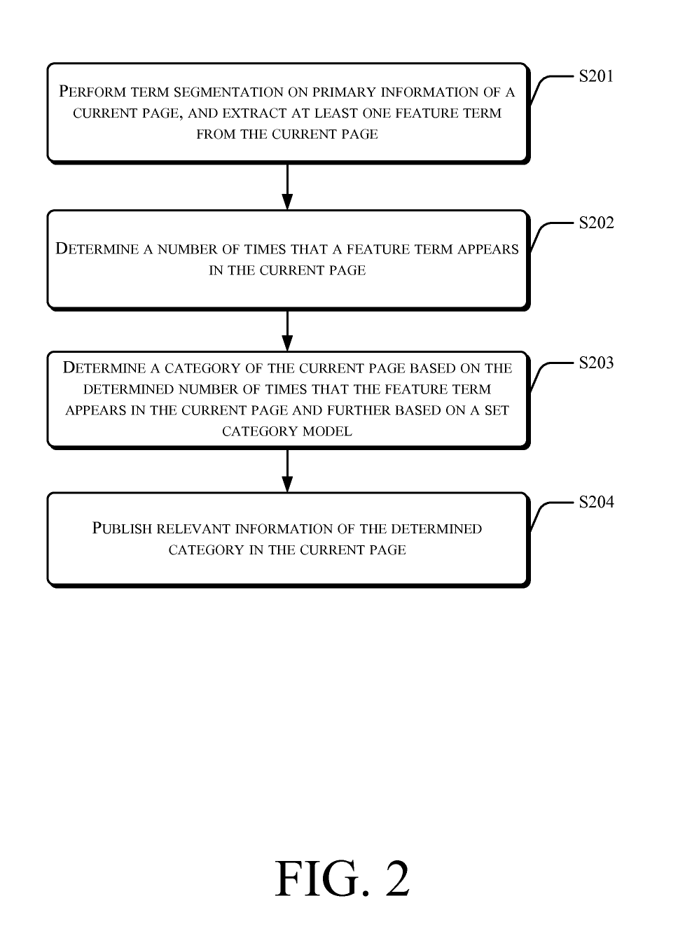

FIG. 2 is a process of publishing information in accordance with the exemplary embodiments of the present disclosure.

Block S201 performs term segmentation on primary information of a current page, and extracts at least one feature term from the current page.

In this embodiment, when performing term segmentation on primary information of a current page, the primary information of the current page may be divided into different regions of sub-information, and the term segmentation can be performed on the divided regions of sub-information.

For example, the primary information in the current page may be business information of a mobile phone of brand A. Generally, business information may be divided into a title region, an attribute content region and a common content region. Therefore, for the primary information, a title is title information of the primary information while attribute content is generally product information (e.g., the specification, the model number, etc.) of the mobile phone of brand A and the common content region is generally description information of the brand A's mobile phone. As such, the primary information may be divided into a title region's sub-information, an attribute content region's sub-information and a common content region's sub-information and the term segmentation can be performed on the sub-information of these regions.

After performing the term segmentation on the primary information, filtering may be performed for the segmented terms to remove predefined terms. The predefined terms may be defined as certain meaningless stop words (such as “of”, etc.) and generalized terms (such as “processing”, “agent”, “wholesale”, etc.). Terms remaining after removing the predefined terms are extracted as feature terms in the current page.

Block S202 determines a number of times that a feature term appears in the current page.

Taking into account a feature term in a practical application, its appearances in different regions may have difference degrees of importance to the current page. In continuing to use the above example, for the primary information of the brand A's mobile phone in the current page, if a feature term appears in the title region, the current page has a higher likelihood to be a page related to the feature term. For example, the title region of the primary information of the current page includes a feature term “brand A”. If a certain feature term appears in the common content region, the current page has a lower likelihood to be a page related to that feature term. For example, the common content region of the primary information of the current page includes a feature term “screen size”.

Therefore, in order to further improve the accuracy of the published information, a method of determining the number of times that the extracted feature term appears in the current page may include: for the at least one extracted feature term: for sub-information of a plurality of regions, separately determining a respective number of times that the feature term appears in sub-information of a region, determining a product of the respective number of times that the feature term appears in the sub-information of the region and a weight set for the sub-information of the region, and setting a sum of the products of the sub-information of the regions as the number of times that the feature term appears in the current page.

In continuing to use the above example, if the extracted feature term “brand A” appears once in the sub-information of the title region of the primary information (the weight set for the sub-information of the title region is 2), five times in the sub-information of the attribute content region (the weight set for the sub-information of the attribute content region is 1.5), twelve times in the sub-information of the common content region (the weight set for the sub-information of the common content region is 1), the determined number of times that the feature term “brand A” appears in the current page is 1×2+5×1.5+12×2=21.5.

Block S203 determines a category of the current page based on the determined number of times that the feature term appears in the current page and further based on a set category model.

The set category model is pre-determined and can be set up in an offline mode. The category of the current page can be determined based on the set category model in an online mode and the number of times that the feature term appears in the current page.

Furthermore, in practical applications, information categories to which relevant information actually belongs may not match with a page category of the page in which the relevant information is published. For example, information categories of relevant information may include: agriculture information, energy information, textile information, metallurgy information, automobile/motorcycle information, fashion information, shoe/bag information, cosmetology information, toy information, etc. And a page category of a web page in which the relevant information is published may include: an education page, a military page, a travel page, an automobile page, a technology page, etc. Thus it would seem, the relevant information categories do not match with the page category. Therefore, in order to further improve the accuracy of information publication, the exemplary embodiments of the present disclosure directly classify a page category of the page in which the relevant information is published based on the information categories of the relevant information, i.e., having these two categories corresponding to a same category system.

The category in the present embodiment refers to an information category or a page category classified using the same category system.

Block S204 publishes relevant information of the determined category in the current page.

Upon determining the category of the current page, relevant information of the category can be published in the current page to complete the publication of the relevant information.

The above process performs term segmentation on primary information of a current page, extracts feature terms, determines a number of times that each extracted feature term appears in the current page, determines a category of the current page based on the determined number of times that each feature term appears in the current page and a set category model, and publishes relevant information of the determined category in the current page. The present embodiment directly extracts a feature term from a current page, and determines a category of the current page based on a number of times that the feature term appears in the current page and further based on a set category model. Therefore, manual labeling of the current page is no longer needed. As such, the efficiency of information publication can be improved, and no human error is introduced, thus improving the accuracy of the information publication.

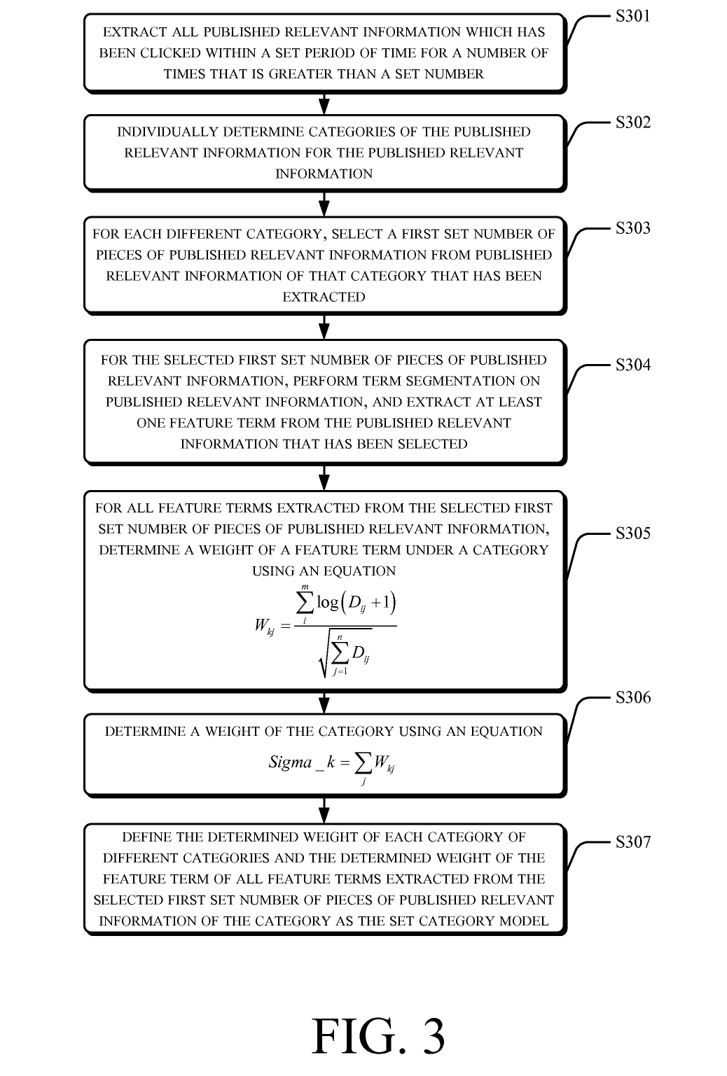

The process shown in FIG. 2 is an online process of determining a category of a current page based on a set category model and a number of times that a feature term appears on the current page, and publishing corresponding relevant information in the current page. FIG. 3 shows an exemplary process of setting up a category model in an offline mode, as described as follows.

FIG. 3 is a process of setting up a category model in accordance with the exemplary embodiments of the present disclosure, which specifically includes the following blocks.

Block S301 extracts all published relevant information which has been clicked within a set period of time for a number of times that is greater than a set number.

In the present embodiment, for relevant information that has been already published in a certain page, if this published relevant information has been clicked in the page for a number of times greater than a set number, the published relevant information may be considered as being published in a page corresponding to a correct category. Therefore, all published relevant information which has been clicked within a set period of time for a number of times that is greater than a set number may be selected for training to obtain a category model in subsequent procedures. The set period of time and the set number may be set up based upon needs. An example may include extracting all published relevant information which has been clicked for more than 100 times within three months.

Block S302 individually determines categories of the published relevant information for the published relevant information.

In other words, a category of each piece of published relevant information that is extracted is determined.

Block S303, for each different category, selects a first set number of pieces of published relevant information from published relevant information of that category that has been extracted.

In other words, from published relevant information of each category, a first set number of pieces of published relevant information are selected. This is because in all published relevant information that is extracted, respective numbers of pieces of published relevant information in different categories may not be the same. For example, among 1000 pieces of published relevant information that are extracted, 500 pieces may belong to category A, 300 pieces may belong to category B, and 200 pieces may belong to category C. Therefore, a same number of pieces of published relevant information in different categories are needed to be selected as training samples to train and obtain a category model during subsequent procedures to improve the accuracy of the category model. For example, 100 pieces (i.e., the first set number as 100) of published relevant information are selected for each category.

Block S304, for the selected first set number of pieces of published relevant information, performs term segmentation on published relevant information, and extracts at least one feature term from the published relevant information that has been selected.

For each different category, upon selecting a first set number of pieces of published relevant information of that category, the present embodiment performs term segmentation on the published relevant information for each piece of published relevant information that has been selected, and extracts feature terms from the published relevant information after segmenting the published relevant information. When the published relevant information is segmented, the same method of segmenting the primary information of the current page may be used. Specifically, the published relevant information is first divided as different regions of sub-information, and the divided regions of sub-information are segmented thereafter. The details thereof are not repeatedly described herein.

Block S305, for all feature terms extracted from the selected first set number of pieces of published relevant information, determines a weight of a feature term under a category using an equation

$${W}_{kj} = \frac{{\sum }_{l}^{m} log ( {D}_{ij} + {l}_{1} )}{\sqrt{{\sum }_{j = 1}^{n} {D}_{ij}}} .$$

k represents that a category thereof is a k^{th} category. j represents that a feature term thereof is a j^{th} feature term among all extracted feature terms. Wₖⱼ is a weight of the feature term in the category. i represents an i^{th} piece of published relevant information within the selected first set number of pieces of published relevant information of the category. m is the first set number. Dᵢⱼ is a number of times that the feature term appears in the i^{th} piece of published relevant information that has been selected. l₁ is a real number not less than one. n is quantity number of all feature terms that are extracted from in the selected first set number of pieces of published relevant information.

For example, for the k^{th} category, three pieces of published relevant information are selected (i.e., the first set number is three and m=3 in the above equation). Feature terms that are extracted from the first piece of published relevant information are feature term A and feature term B. Feature terms that are extracted from the second piece of published relevant information are feature term B and feature term C. Feature terms that are extracted from the third piece of published relevant information are feature term A and feature term D. Therefore, all feature terms that are extracted from these three selected pieces of published relevant information of the k^{th} category are the feature term A, the feature term B, the feature term C and the feature term D. In other words, the number of all feature terms that are extracted in the selected first set number of published relevant information is four, i.e., n=4 in the above equation.

When determining the weight of each feature term in the k^{th} category using the above equation, the number of times that each feature term appears in all published relevant information that has been selected is first determined. Specifically, Dᵢⱼ, the number of times that the j^{th} feature term appears in the i^{th} piece of published relevant information, is determined. Continuing the above example, a value range of i is 1-3 and a value range of j is 1-4 in the above equation. When determining Dᵢⱼ, the same method of determining a number of times that an extracted feature term appears in a current page (as shown in FIG. 2) may be used. Specifically, for each divided region of sub-information, a number of times that the j^{th} feature term appears in the respective region of sub-information of the i^{th} piece of published relevant information is individually determined. Furthermore, a product of the number of times and a weight value set for this region of sub-information is determined. A sum of the products of the divided region of sub-information is set as Dᵤ, the number of time that the j^{th} feature term appears in the i^{th} piece of published relevant information.

Block S306 determines a weight of the category using an equation Sigma_k=ΣⱼWₖⱼ.

Sigma_k is the weight of the category. In other words, after determining the weight Wₖⱼ of each feature term of the k^{th} category that is extracted from the first set number of pieces of published relevant information belonging to the k^{th} category according to the method in block S305, the sum of the weights of all feature terms of the k^{th} category is set as the weight of the k^{th} category.

Block S307 defines the determined weight of each category of different categories and the determined weight of the feature term of all feature terms extracted from the selected first set number of pieces of published relevant information of the category as the set category model.

Specifically, if the number of the classified categories is K, Sigma_k that is determined for each category (with kε[1, K]) and each Wₖⱼ that is determined for each category are defined as the set category model.

Furthermore, a same feature term may appear in different pieces of published relevant information. In order to further improve an accuracy of the set category model and hence improve an accuracy of information publication, after determining the weight Wₖⱼ of the j^{th} feature term of the k^{th} category according to the method of block S305, the present embodiment may further separately determine, for each category, a number of pieces of published relevant information that include the feature term within the selected first set number of published relevant information of the category, determine a sum of the determined number for each category, and redefines a weight of the feature term in the category as a product of the weight of the feature term in the category and a reciprocal of the sum.

In other words, after determining Wₖⱼ, IDFₖⱼ is determined for each category. IDFₖⱼ represents the number of pieces of published relevant information that include the j^{th} feature term within the selected first set number of the published relevant information of the k^{th} category. Again, if the number of classified categories is taken to be K, IDFⱼ=Σₖ₌₁^{K}IDFₖⱼ is determined. IDFⱼ is the sum of the determined number of each category. Finally,

$${W}_{kj}^{′} = {W}_{kj} \times \frac{1}{{IDF}_{j}}$$

is determined. W′ₖⱼ is the redefined weight of the j^{th} feature term of the k^{th} category.

Furthermore, Sigma_k is determined under a circumstance that a same number of pieces of published relevant information are selected from each category. However, in reality, the numbers of pieces of published relevant information that are extracted (i.e., from all pieces of published relevant information that have been clicked for a number of times which is greater than a set number within a set time period) under different categories may be different. For example, the number of extracted pieces of published relevant information with the number of clicks greater than a set number within a set period of time may be one thousand. The number of pieces of published relevant information of category 1 is five hundred, the number of pieces of published relevant information of category 2 is three hundred, and the number of pieces of the published relevant information of category 3 is two hundred. When Sigma_{—}1, Sigma_{—}2 and Sigma_{—}3 are determined, they are determined under a circumstance that a same number of pieces of published relevant information are selected from different categories. Therefore, the present embodiment may further adjust Sigma_{—}1, Sigma_{—}2 and Sigma_{—}3 such that adjusted Sigma_{—}1, Sigma_{—}2 and Sigma_{—}3 can satisfy a real situation in a better way, thus further improving the accuracy of the obtained category model and the accuracy of the published information.

Specifically, after determining the weight of the category, the number of all extracted pieces of published relevant information that have been clicked for a number of times greater than a preset number within a set period of time is defined as a first parameter. From among all the extracted pieces of published relevant information, the number of pieces of published relevant information that belongs to the category is defined as a second parameter. A ratio between the second parameter and the first parameter is determined. And a product of the determined weight of the category and this ratio is redefined as the weight of category.

In other words, after determining the weight Sigma_k of the k^{th} category according to the method of block S306, the number of all pieces of published relevant information that have been extracted at block S301 and are found to have been clicked for a number of times greater than a preset number within a set period of time is further defined as a first parameter Q. From among all the extracted pieces of published relevant information, the number of pieces of published relevant information that belongs to the k^{th} category is defined as a second parameter Qₖ. A ratio Qₖ/Q between the second parameter Qₖ and the first parameter Q is determined. Finally,

$${Sigma\_k}^{′} = Sigma\_k \times \frac{{Q}_{k}}{Q}$$

is determined, where Sigma_k′ is defined as a new weight of category.

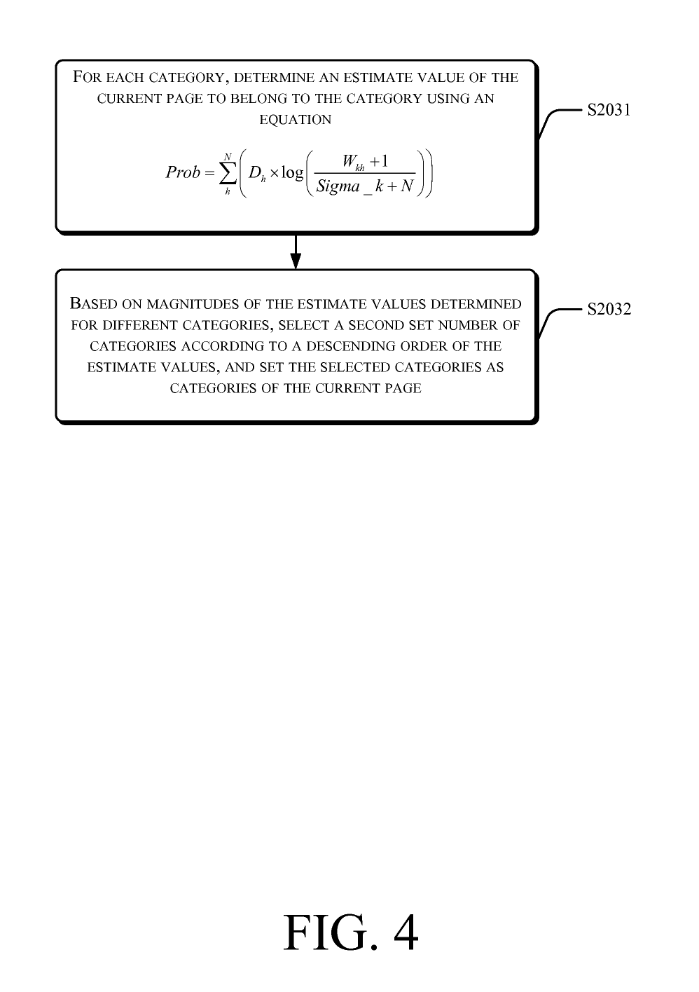

The process of setting up a category model as shown in FIG. 3 may be performed in an offline mode. After the category model is obtained using this method, the process of determining a category of a current page using this category model in an online mode, which is the process shown in block S203 of FIG. 2, is shown in FIG. 4.

FIG. 4 illustrates a detailed process of determining a category of a current page as provided in the exemplary embodiments of the present disclosure, which specifically includes the following procedures:

Block S2031, for each category, determines an estimate value of the current page to belong to the category using an equation:

$$Prob = {\sum }_{h}^{N} ( {D}_{h} \times log ( \frac{{W}_{kh} + {l}_{2}}{Sigma\_k + N} ) ) .$$

Prob is an estimate value of the current page to belong to the category. N is the number of feature terms extracted from the current page. h represents the h^{th} feature term extracted from the current page. Dₕ is a number of times that the h^{th} extracted feature term appears in the current page. Wₖₕ is a weight of the h^{th} extracted feature term under the k^{th} category. l₂ is a real number that is not less than one.

Specifically, the present embodiment estimates a probability that the current page belongs to each category using the above equation based on the number of times that each feature term (extracted from primary information of the current page) appears in the current page and the set category model, to obtain an estimate value Prob that the current page may belong to each category.

Given that Wₖₕ is the weight of the h^{th} feature term in the k^{th} category, if the weight of the h^{th} feature term in the k^{th} category does not exist in the set category model when an estimate value is determined using the above equation, this indicates that all pieces of published relevant information under the k^{th} category do not include the h^{th} feature term when the category model is set up. In this case, the value of Wₖₕ is set to be zero, i.e., the weight of the h^{th} feature term in the k^{th} category is zero by default.

Furthermore, Wₖₕ in the above equation may be replaced by W′ₖₕ, which is re-determined when the category model is set. Also, Sigma_k may be replaced by Sigma_k′, which is re-determined when the category model is set to further improve the accuracy of the published information.

Block S2032, based on magnitudes of the estimate values determined for different categories, selects a second set number of categories according to a descending order of the estimate values, and sets the selected categories as categories of the current page.

In this embodiment, a page may publish relevant information of different categories. Therefore, in response to determining an estimate value of the current page to belong to each category, a second set number of categories that have higher estimate values may be selected as the categories of the current page. The second set number can be defined based on actual needs.

For example, the second set number may be set as five. After determining an estimate value of the current page to belong to each category, the categories may be arranged in a descending order of respective determined estimate values. The first five categories may be selected, i.e., the five categories having the larger determined estimate values are selected as the categories of the current page.

In subsequent procedures, relevant information respectively belonging to these five categories is published onto the current page to complete the publication of the relevant information.

The method of publishing information in the exemplary embodiments of the present disclosure may be applied to different scenarios of information publication, including scenarios of publishing business information such as B2B, B2C, C2C, and other information publication scenarios.

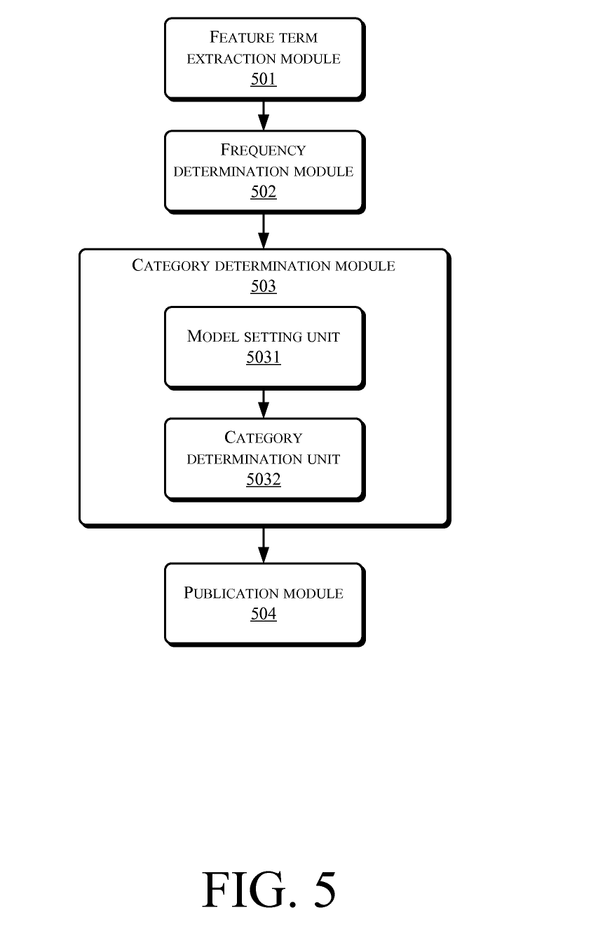

FIG. 5 is a structural diagram of an apparatus of publishing information in accordance with the exemplary embodiments of the present disclosure, which specifically includes:

a feature term extraction module 501, used for performing term segmentation on primary information in a current page and extracting at least one feature term from the current page;

a frequency determination module 502, used for determining a number of times that the extracted feature term appears in the current page;

a category determination module 503, used for determining a category of the current page based on the determined number times that the feature term appears in the current page and a set category model; and

a publication module 504, used for publishing relevant information that belongs to determined category in the current page.

The feature term extraction module 501 is specifically used for dividing the primary information of the current page into different regions of sub-information, and separately performing term segmentation on the divided regions of sub-information.

The frequency determination module 502 is specifically used for separately determining a respective number of times that the feature term appears in a region of sub-information for the divided regions of sub-information, determining a product of the respective number of times that the feature term appears in the region of sub-information and a weight set for the region of sub-information, and setting a sum of the products of the regions of the sub-information as the number of times that the feature term appears in the current page.

The category determination module 503 includes:

a model setting unit 5031, used for extracting all published relevant information which has been clicked within a set period of time for a number of times that is greater than a set number; individually determining categories of the published relevant information for the published relevant information; performing the following for each different category: selecting a first set number of published relevant information from published relevant information of the category that has been extracted; for the selected first set number of pieces of published relevant information, performing term segmentation on published relevant information, and extracting at least one feature term from the published relevant information that is selected; for all feature terms extracted from the selected first set number of the published relevant information, determining a weight of a feature term under a category using an equation

$${W}_{kj} = \frac{{\sum }_{l}^{m} log ( {D}_{ij} + {l}_{1} )}{\sqrt{{\sum }_{j = 1}^{n} {D}_{ij}}} ,$$

where k represents that a category thereof is a k^{th} category, j represents that a feature term thereof is a j^{th} feature term in all extracted feature terms, Wₖⱼ is a weight of the feature term in the category, i represents an i^{th} piece of published relevant information in the selected first set number of the published relevant information of the category, m is the first set number, Dᵢⱼ is a number of times that the feature term appears in the i^{th} piece of published relevant information that has been selected, l₁ is a real number not less than one, n is quantity number of all feature terms that are extracted from in the selected first set number of the published relevant information; determining a weight of the category using an equation Sigma_k=ΣⱼWₖⱼ, where Sigma_k is the weight of said category; and defining the determined weight of each category of different categories, and the determined weight of the feature term of all feature terms extracted from the selected first set number of published relevant information of the category as the set category model.

The model setting unit 5031 may be used for, after determining the weight of the feature term of the category, separately determining, for each category, a number of pieces of published relevant information that include the feature term within the selected first set number of published relevant information of the category, determining a sum of the determined number for each category, and redefining a weight of the feature term in the category as a product of the weight of the feature term in the category and a reciprocal of the sum.

The model setting unit 5031 may be used for, after determining the weight of the category, defining the number of all extracted pieces of published relevant information that have been clicked for a number of times greater than a preset number within a set period of time as a first parameter, defining the number of pieces of published relevant information that belongs to the category as a second parameter from among all the extracted pieces of published relevant information, determining a ratio between the second parameter and the first parameter, redefining a product of the determined weight of the category and this ratio as the weight of category.

The category determination module 503 also includes:

a category determination unit 5032 used for, for each category, determining an estimate value of the current page to belong to the category using an equation

$$Prob = {\sum }_{h}^{N} ( {D}_{h} \times log ( \frac{{W}_{kh} + {l}_{2}}{Sigma\_k + N} ) ) ,$$

where Prob is an estimate value of the current page to belong to the category, N is a number of extracted feature terms from the current page, h represents the h^{th} extracted feature term from the current page, Dₕ is a number of times that the h^{th} extracted feature term appears in the current page, Wₖₕ is a weight of the h^{th} extracted feature term under the k^{th} category, l₂ is a real number that is not less than one; based on magnitudes of the estimate values determined for different categories, selecting a second set number of categories according to a descending order of the estimate values, and setting the selected categories as categories of the current page.

The exemplary embodiments of the present disclosure provide a method and an apparatus of publishing information. The method segments primary information of a current page, extracts at least one feature term from the current page, determines a number of times that the extracted feature term appears in the current page, determines a category of the current page based on the determined number of times that the feature term appears in the current page and a set category model, and publishes relevant information that belongs to the determined category in the current page. By directly extracting a feature term from a current page and determining a category of the current page based on a number of times that the feature term appears in the current page and a set category model, the exemplary embodiments do not need to perform manual labeling for the current page. As such, the efficiency of information publication can be improved. Furthermore, the accuracy of the information publication is increased because no human error is introduced.

A technical person skilled in the art should understand that the embodiments of the present disclosure may be implemented as methods, systems, or products of computer software. Therefore, the present disclosure may be implemented in forms of hardware, software, or a combination of hardware and software. Further, the present disclosure may be implemented in the form of products of computer software executable on one or more computer readable storage media (including but not limited to disk storage device, CD-ROM, optical storage device, etc.) that include computer readable program instructions.

The present disclosure is described in accordance with flowcharts and/or block diagrams of the exemplary methods, apparatuses (devices) and computer program products. It should be understood that each process and/or block and combinations of the processes and/or blocks of the flowcharts and/or the block diagrams may be implemented in the form of computer program instructions. Such computer program instructions may be provided to a general purpose computer, a special purpose computer, an embedded processor or another processing apparatus having a programmable data processing device to generate a machine, so that an apparatus having the functions indicated in one or more blocks described in one or more processes of the flowcharts and/or one or more blocks of the block diagrams may be implemented by executing the instructions by the computer or the other processing apparatus having programmable data processing device.

Such computer program instructions may also be stored in a computer readable memory device which may cause a computer or another programmable data processing apparatus to function in a specific manner, so that a manufacture including an instruction apparatus may be built based on the instructions stored in the computer readable memory device. That instruction device implements functions indicated by one or more processes of the flowcharts and/or one or more blocks of the block diagrams.

The computer program instructions may also be loaded into a computer or another programmable data processing apparatus, so that a series of operations may be executed by the computer or the other data processing apparatus to generate computer implemented processing. Therefore, the instructions executed by the computer or the other programmable apparatus may be used to implement one or more processes of the flowcharts and/or one or more blocks of the block diagrams.

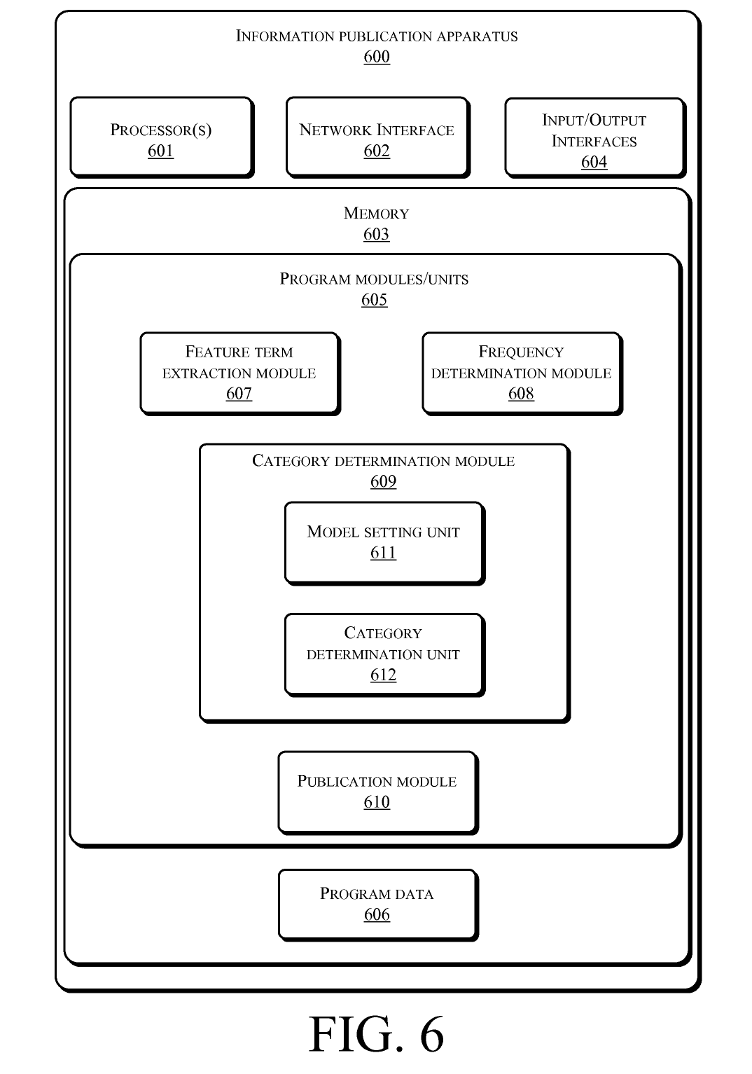

For example, FIG. 6 illustrates an exemplary information publishing apparatus 600, such as the apparatus as described above, in more detail. In one embodiment, the apparatus 600 can include, but is not limited to, one or more processors 601, a network interface 602, memory 603, and an input/output interface 604.

The memory 603 may include computer-readable media in the form of volatile memory, such as random-access memory (RAM) and/or non-volatile memory, such as read only memory (ROM) or flash RAM. The memory 503 is an example of computer-readable media.

Computer-readable media includes volatile and non-volatile, removable and non-removable media implemented in any method or technology for storage of information such as computer readable instructions, data structures, program modules, or other data. Examples of computer storage media includes, but is not limited to, phase change memory (PRAM), static random-access memory (SRAM), dynamic random-access memory (DRAM), other types of random-access memory (RAM), read-only memory (ROM), electrically erasable programmable read-only memory (EEPROM), flash memory or other memory technology, compact disk read-only memory (CD-ROM), digital versatile disks (DVD) or other optical storage, magnetic cassettes, magnetic tape, magnetic disk storage or other magnetic storage devices, or any other non-transmission medium that can be used to store information for access by a computing device. As defined herein, computer-readable media does not include transitory media such as modulated data signals and carrier waves.

The memory 603 may include program modules/units 605 and program data 606. In one embodiment, the program modules/units 605 may include a feature term extraction module 607, a frequency determination module 608, a category determination module 609 and a publication module 610. In some embodiments, the category determination module 609 may include a model setting unit 611 and a category determination unit 612. Details about these program modules and/or units thereof may be found in the foregoing embodiments described above.

Although preferred embodiments of the present disclosure are provided, a technical person skilled in the art may change and modify theses exemplary embodiments upon understanding the underlying inventive concepts thereof. Therefore, claims attached herein are intended to cover the preferred embodiments and all the changes and modifications that fall into the scope of the present disclosure. Apparently, a technical person skilled in the art may make changes and modifications of the present application without deviating from the spirit and scope of the present disclosure. If these changes and modifications are within the scope of the claims and their equivalents of the present disclosure, the present disclosure intends to covers such changes and modifications.

What is claimed is:

1. A method of publishing information, comprising:
performing term segmentation on primary information of a current page and extracting at least one feature term from the current page;
determining a number of times that the extracted feature term appears in the current page;
determining a category of the current page based on the determined number of times that the feature term appears in the current page and a set category model; and
publishing relevant information that belongs to the determined category in the current page.

2. The method as recited in claim 1, wherein performing term segmentation on the primary information of the current page comprises:
dividing the primary information of the current page into different regions of sub-information; and
separately segmenting the divided regions of sub-information.

3. The method as recited in claim 2, wherein determining the number of times that the extracted feature term appears in the current page comprises:
for the at least one feature term that is extracted, performing the following:
for each divided region of sub-information, determining a number of times that the feature term appears on the divided region of sub-information;
determining a product of the number of times that the feature term appears in the divided region of sub-information and a weight set for the region sub-information; and
defining a sum of products of the divided regions of sub-information as the number of times said that the feature term appears in the current page.

4. The method as recited in claim 1, wherein the set category model comprises:
extracting all published relevant information which has been clicked within a set period of time for a number of times that is greater than a set number;
individually determining categories of the published relevant information for the published relevant information;
for each different category, performing the following:
selecting a first set number of published relevant information from published relevant information of the category that has been extracted;
for the selected first set number of pieces of published relevant information, performing term segmentation on published relevant information, and extracting at least one feature term from the published relevant information that is selected;
for all feature terms extracted from the selected first set number of the published relevant information, determining a weight of a feature term under a category using an equation
$${W}_{kj} = \frac{{\sum }_{l}^{m} log ( {D}_{ij} + {l}_{1} )}{\sqrt{{\sum }_{j = 1}^{n} {D}_{ij}}} ,$$
where k represents that a category thereof is a k^{th} category, j represents that a feature term thereof is a j^{th} feature term in all extracted feature terms, Wₖⱼ is a weight of the feature term in the category, i represents an i^{th} piece of published relevant information in the selected first set number of the published relevant information of the category, m is the first set number, Dᵢⱼ is a number of times that the feature term appears in the i^{th} published relevant information that has been selected, l₁ is a real number not less than one, n is quantity number of all feature terms that are extracted from in the selected first set number of the published relevant information;
determining a weight of the category using an equation Sigma_k=ΣⱼWₖⱼ, where Sigma_k is the weight of said category; and
defining the determined weight of each category of different categories, and the determined weight of the feature term of all feature terms extracted from the selected first set number of published relevant information of the category as the set category model.

5. The method as recited claim 1, wherein after determining the weight of the feature term in the category, the method further comprises:
separately determining, for each category, a number of pieces of published relevant information that include the feature term within the selected first set number of published relevant information of the category;
determining a sum of the determined number for each category; and
redefining a weight of the feature term in the category as a product of the weight of the feature term in the category and a reciprocal of the sum.

6. The method as recited in claim 1, wherein after determining the weight of the category, the method further comprises:
defining the number of all extracted pieces of published relevant information that have been clicked for a number of times greater than a preset number within a set period of time as a first parameter;
defining the number of pieces of published relevant information that belongs to the category as a second parameter from among all the extracted pieces of published relevant information;
determining a ratio between the second parameter and the first parameter; and
redefining a product of the determined weight of the category and this ratio as the weight of category.

7. The method as recited in claim 1, wherein determining the category of the current page based on the determined number of times that the feature term appears in the current page and the set category model comprises:
for each category, determining an estimate value of the current page to belong to the category using an equation
$$Prob = {\sum }_{h}^{N} ( {D}_{h} \times log ( \frac{{W}_{kh} + {l}_{2}}{Sigma\_k + N} ) ) ,$$
where Prob is an estimate value of the current page to belong to the category, N is a number of extracted feature terms from the current page, h represents the h^{th} extracted feature term from the current page, Dₕ is a number of times that the h^{th} extracted feature term appears in the current page, Wₖₕ is a weight of the h^{th} extracted feature term under the k^{th} category, l₂ is a real number that is not less than one; and
based on magnitudes of the estimate values determined for different categories, selecting a second set number of categories according to a descending order of the estimate values, and setting the selected categories as categories of the current page.

8. An apparatus of publishing information, comprising:
a feature term extraction module, used for performing term segmentation on primary information in a current page and extracting at least one feature term from the current page;
a frequency determination module, used for determining a number of times that the extracted feature term appears in the current page;
a category determination module, used for determining a category of the current page based on the determined number times that the feature term appears in the current page and a set category model; and
a publication module, used for publishing relevant information that belongs to determined category in the current page.

9. The apparatus as recited in claim 8, wherein dividing the primary information of the current page into different regions of sub-information, and separately performing term segmentation on the divided regions of sub-information.

10. The apparatus as recited in claim 9, wherein the frequency determination module is used for separately determining a respective number of times that the feature term appears in a region of sub-information for the divided regions of sub-information, determining a product of the respective number of times that the feature term appears in the region of sub-information and a weight set for the region of sub-information, and setting a sum of the products of the regions of the sub-information as the number of times that the feature term appears in the current page.

11. The apparatus as recited in claim 8, wherein the category determination module comprises:
a model setting unit, used for extracting all published relevant information which has been clicked within a set period of time for a number of times that is greater than a set number; individually determining categories of the published relevant information for the published relevant information; performing the following for each different category: selecting a first set number of published relevant information from published relevant information of the category that has been extracted; for the selected first set number of pieces of published relevant information, performing term segmentation on published relevant information, and extracting at least one feature term from the published relevant information that is selected; for all feature terms extracted from the selected first set number of the published relevant information, determining a weight of a feature term under a category using an equation
$${W}_{kj} = \frac{{\sum }_{l}^{m} log ( {D}_{ij} + {l}_{1} )}{\sqrt{{\sum }_{j = 1}^{n} {D}_{ij}}} ,$$
where k represents that a category thereof is a k^{th} category, j represents that a feature term thereof is a j^{th} feature term in all extracted feature terms, Wₖⱼ is a weight of the feature term in the category, i represents an i^{th} piece of published relevant information in the selected first set number of the published relevant information of the category, m is the first set number, Dᵢⱼ is a number of times that the feature term appears in the i^{th} published relevant information that has been selected, l₁ is a real number not less than one, n is quantity number of all feature terms that are extracted from in the selected first set number of the published relevant information; determining a weight of the category using an equation Sigma_k=ΣⱼWₖⱼ, where Sigma_k is the weight of said category; and defining the determined weight of each category of different categories, and the determined weight of the feature term of all feature terms extracted from the selected first set number of published relevant information of the category as the set category model.

12. The apparatus as recited in claim 11, wherein the model setting unit is further used for, after determining the weight of the feature term of the category, separately determining, for each category, a number of pieces of published relevant information that include the feature term within the selected first set number of published relevant information of the category, determining a sum of the determined number for each category, and redefining a weight of the feature term in the category as a product of the weight of the feature term in the category and a reciprocal of the sum.

13. The apparatus as recited in claim 11, wherein the model setting unit is further used for, after determining the weight of the category, defining the number of all extracted pieces of published relevant information that have been clicked for a number of times greater than a preset number within a set period of time as a first parameter, defining the number of pieces of published relevant information that belongs to the category as a second parameter from among all the extracted pieces of published relevant information, determining a ratio between the second parameter and the first parameter, redefining a product of the determined weight of the category and this ratio as the weight of category.

14. The apparatus as recited in claim 8, wherein the category determination module comprises a category determination unit used for, for each category, determining an estimate value of the current page to belong to the category using an equation
$$Prob = {\sum }_{h}^{N} ( {D}_{h} \times log ( \frac{{W}_{kh} + {l}_{2}}{Sigma\_k + N} ) ) ,$$
where Prob is an estimate value of the current page to belong to the category, N is a number of extracted feature terms from the current page, h represents the h^{th} extracted feature term from the current page, Dₕ is a number of times that the h^{th} extracted feature term appears in the current page, Wₖₕ is a weight of the h^{th} extracted feature term under the k^{th} category, l₂ is a real number that is not less than one; based on magnitudes of the estimate values determined for different categories, selecting a second set number of categories according to a descending order of the estimate values, and setting the selected categories as categories of the current page.

15. One or more storage media storing executable instructions that, when executed by one or more processors, cause the one or more processors to perform acts comprising:
performing term segmentation on primary information of a current page and extracting at least one feature term from the current page;
determining a number of times that the extracted feature term appears in the current page;
determining a category of the current page based on the determined number of times that the feature term appears in the current page and a set category model; and
publishing relevant information that belongs to the determined category in the current page.

16. The one or more storage media as recited in claim 15, wherein performing term segmentation on the primary information of the current page comprises:
dividing the primary information of the current page into different regions of sub-information; and
separately segmenting the divided regions of sub-information.

17. The one or more storage media as recited in claim 16, wherein determining the number of times that the extracted feature term appears in the current page comprises:
for the at least one feature term that is extracted, performing the following:
for each divided region of sub-information, determining a number of times that the feature term appears on the divided region of sub-information;
determining a product of the number of times that the feature term appears in the divided region of sub-information and a weight set for the region sub-information; and
defining a sum of products of the divided regions of sub-information as the number of times said that the feature term appears in the current page.

18. The one or more storage media as recited in claim 15, wherein the set category model comprises:
extracting all published relevant information which has been clicked within a set period of time for a number of times that is greater than a set number;
individually determining categories of the published relevant information for the published relevant information;
for each different category, performing the following:
selecting a first set number of published relevant information from published relevant information of the category that has been extracted;
for the selected first set number of pieces of published relevant information, performing term segmentation on published relevant information, and extracting at least one feature term from the published relevant information that is selected;
for all feature terms extracted from the selected first set number of the published relevant information, determining a weight of a feature term under a category using an equation
$${W}_{kj} = \frac{{\sum }_{l}^{m} log ( {D}_{ij} + {l}_{1} )}{\sqrt{{\sum }_{j = 1}^{n} {D}_{ij}}} ,$$
where k represents that a category thereof is a k^{th} category, j represents that a feature term thereof is a j^{th} feature term in all extracted feature terms, Wₖⱼ is a weight of the feature term in the category, i represents an i^{th} piece of published relevant information in the selected first set number of the published relevant information of the category, m is the first set number, Dᵢⱼ is a number of times that the feature term appears in the i^{th} published relevant information that has been selected, l₁ is a real number not less than one, n is quantity number of all feature terms that are extracted from in the selected first set number of the published relevant information;
determining a weight of the category using an equation Sigma_k=ΣⱼWₖⱼ, where Sigma_k is the weight of said category; and
defining the determined weight of each category of different categories, and the determined weight of the feature term of all feature terms extracted from the selected first set number of published relevant information of the category as the set category model.

19. The one or more storage media as recited in claim 15, wherein after determining the weight of the feature term in the category, the acts further comprises:
separately determining, for each category, a number of pieces of published relevant information that include the feature term within the selected first set number of published relevant information of the category;
determining a sum of the determined number for each category; and
redefining a weight of the feature term in the category as a product of the weight of the feature term in the category and a reciprocal of the sum.

20. The one or more storage media as recited in claim 15, wherein after determining the weight of the category, the acts further comprises:
defining the number of all extracted pieces of published relevant information that have been clicked for a number of times greater than a preset number within a set period of time as a first parameter;
defining the number of pieces of published relevant information that belongs to the category as a second parameter from among all the extracted pieces of published relevant information;
determining a ratio between the second parameter and the first parameter; and
redefining a product of the determined weight of the category and this ratio as the weight of category.
